(19) United States
(12) Patent Application Publication
(10) Pub. No.: US 2025/0116075 A1
(43) Pub. Date: Apr. 10, 2025

(54) PROCESS FOR PRODUCTION OF AN INFILL MATERIAL FOR A SYNTHETIC TURF SURFACE

(71) Applicant: SUE - SPORTS UNIFIED EUROPE, LDA, Braga (PT)

(72) Inventors: Reed J. SEATON, AUSTIN, TX (US); Luis Filipe V. MACEDO, BRAGA (PT)

(21) Appl. No.: 18/833,808

(22) PCT Filed: Dec. 23, 2022
(86) PCT No.: PCT/IB2022/062733

§ 371 Date: Jul. 26, 2024

(30) Foreign Application Priority Data
Jan. 28, 2022 (PT) 117768
Feb. 28, 2022 (EP) 22159107.6

(51) Int. Cl. E01C 13/08; F26B 3/08; F26B 11/04

(52) U.S. Cl. CPC E01C 13/08; F26B 3/08; F26B 11/0481; F26B 2200/02; F26B 2200/08

(57) ABSTRACT

Process for production of an infill material (200) for a synthetic turf surface (400), wherein the infill material (200) comprises a plurality of granules (201), the process comprising: —providing particles (2) made of a plant material; —tumble-drying the particles (2) for obtaining the granules (201).

### TECHNICAL FIELD OF THE INVENTION

The present invention relates to a process for production of an infill material for a synthetic turf surface.

### STATE OF THE ART

In the making of surfaces for sports use (e.g., soccer fields, football fields, rugby fields, baseball fields, etc.) and/or for decorative use (e.g., gardens), a rigid and compact substrate (e.g., in clay or asphalt) is typically prepared and then a synthetic turf mat comprising artificial fibres simulating the natural grass is laid above the substrate. In addition, a layer of material called infill (which can be made of various materials such as rubber granules, e.g., recycled; sand; plant material, such as cork and/or coconut; etc.) is typically spread on the synthetic turf mat between the artificial fibres. The infill structurally stabilizes the synthetic turf mat and/or improves its aesthetic quality, making it look more likely to the natural grass (as it facilitates the upright position of the artificial fibres), and/or improves the performance properties of the mat (for example in terms of mechanical response of the mat, rolling/bouncing of the ball, etc.) thus facilitating its use for sports.

US2010055461A1, US2018080183A1, WO2006109110A1 and US2015252537A1 disclose a respective infill material originating from plant materials.

### SUMMARY OF THE INVENTION

The Applicant has realized that known infill materials have some drawbacks or can be improved in one or more aspects. The Applicant has observed that the infill material disclosed in US2010055461A1, US2018080183A1, WO2006109110A1 and US2015252537A1 are unsatisfactory in terms of abrasion of the synthetic turf surface and/or in terms of undesired proliferation of microorganisms on the synthetic turf surface.

For example, the Applicant has observed that the production process of the infill material, especially when the latter is made of a hard plant material as disclosed in US2010055461A1 (e.g., ground walnut shells) or in US2018080183A1 (olive pit particles), can lead to the formation of particles having sharp edges on their outer surface and/or to an uncontrollable and unpredictable shape of particles which results in a high variation of the shape among the particles. According to the Applicant, on one hand, the sharp edges can cause a damaging (e.g., wear/abrasion) of the artificial fibres and/or of the synthetic turf mat due to the friction (e.g., by rubbing) between particles and artificial fibres and/or synthetic turf mat during use of the synthetic turf surface. On the other hand, the highly irregular shape between the particles can cause an uneven damaging of the artificial fibres and/or of the synthetic turf mat in some areas of the synthetic turf surface with an early need to replace the synthetic turf surface.

The Applicant has also observed that the infill materials disclosed in the above documents can have an excessive moisture content at the end of the respective production process and/or they can possibly retain an excessive amount of water (e.g., rain or actively sprayed on the mat) which realizes the conditions for an uncontrollable and/or excessive proliferation of microorganisms on the synthetic turf surface with consequent rotting of the infill material and/or loss of its performance properties.

The Applicant has therefore faced the problem of obtaining, through an ecologically-friendly production process, an infill material for a synthetic turf surface which does not cause an excessive abrasion of the synthetic turf surface and, at the same time, does not cause an undesired/uncontrollable proliferation of microorganisms on the synthetic turf surface.

According to the Applicant, the above problem is solved by a process for production of an infill material for a synthetic turf surface according to the attached claims and/or having one or more of the following features.

According to an aspect the invention relates to a process for production of an infill material for a synthetic turf surface, wherein the infill material comprises a plurality of granules, the process comprising:
providing particles made of a plant material;
tumble-drying said particles for obtaining said granules.

The Applicant has observed that the tumble-drying operation smooths the outer surface of the particles thus limiting, in use, the wear (e.g., for abrasion) of the synthetic turf surface, since the granules do not (substantially) have sharp edges or spikes on their outer surface. The Applicant has also observed that the tumble-drying operation provides the desired shape (with substantially no sharp edges) to the granules in a reliable and repeatable way thus providing for a consistency in the shape of the granules which limits, or avoids, uneven damages of the synthetic turf surface during use of the same.

In addition, the Applicant has observed that the tumble-drying operation provides a drying action which lower the moisture content of the plant material (i.e., provides a substantial reduction of the moisture content in the plant material with respect to the initial moisture content). In use (when the granules are on the synthetic turf surface), this allows limiting (or avoiding) the uncontrollable proliferation of microorganisms on the synthetic turf surface which would cause a rotting of the infill material with consequent loss of its performance properties.

The present invention in one or more of the aforesaid aspects can have one or more of the following preferred features. Preferably, before said tumble-drying, it is provided washing (preferably with water) said particles. In this way it is possible reducing, or eliminating, the presence of contaminating agents (e.g., some microorganisms, impurities, toxic substances) in the plant material.

Preferably said tumble-drying comprises providing a tumble-drier.

Preferably said tumble-drier comprises a hollow main body rotatable around a (preferably horizontal) rotation axis. In the following, “axial” generally refers to a direction parallel to the rotation axis.

Preferably said hollow main body is made of metal, e.g., steel or iron alloy.

Preferably said hollow main body comprises an inner chamber and an inner surface defining said inner chamber.

Preferably said hollow main body (and said inner chamber and said inner surface) has cylindrical shape symmetric with respect to said rotation axis. In the following, “radial” generally refers to a radial direction in case of such cylindrical shape.

Preferably said hollow main body comprises a plurality of projections protruding (substantially radially) from the inner surface (in order to contribute to the smoothing action on the particles).

Preferably said projections form a plurality of active surfaces. Preferably each of said active surfaces develop (continuously or stepwise) along an entire axial length of said hollow main body. Preferably said active surfaces are (evenly) distributed on the inner surface (e.g., evenly angularly distributed around the rotation axis). Preferably each active surface is not parallel to the rotation axis. Preferably each active surface forms a helix around the rotation axis.

In such a way the projections also exert a transport action on the particles.

Preferably a pitch of the helix is greater than or equal to half of a total length, more preferably greater than or equal to said total length, and/or less than or equal to two times said entire axial length.

Preferably said projections comprise a plurality of lamellae each having a laminar (and preferably rectangular) shape.

Preferably said lamellae are distributed on said inner surface of the hollow main body in rows (preferably at least fifteen, more preferably at least twenty, rows), each row comprising a sequence of lamellae developing along the axial direction for forming a respective active surface (corresponding to respective faces of the lamellae of the respective row facing forward with respect to the rotation).

Preferably, in each row, the lamellae of each pair of consecutive lamellae are at least partially circumferentially staggered (on a same side). Preferably, in each row, the lamellae of each pair of consecutive lamellae are partially mutually overlapped with respect to the axial direction (in order to confine the axial flux of the particles).

Preferably the active surfaces (e.g., the lamellae) form, together with the inner surface, an endless screw along the axial direction. In this way it is possible to axially advance the particles along the tumble-drier in a simple manner.

Preferably an angular distance, taken on the cross section of the hollow main body (or of the inner chamber), between two consecutive active surfaces is constant, more preferably said angular distance is greater than or equal to 5°, more preferably greater than or equal to 10°, and/or less than or equal to 30°, more preferably less than or equal to 20°. In this way it is possible to provide a constant and suitable advancement rate of the particles in order to improve and/or homogenize the smoothening and drying actions.

Preferably each of said lamellae has a length (i.e., a dimension taken along a main development direction of the respective lamella, which may be axial) greater than or equal to 15 cm, more preferably greater than or equal to 18 cm, and/or less than or equal to 35 cm, more preferably less than or equal to 30 cm. Preferably each of said lamellae has a height (i.e., a dimension taken along a direction perpendicular to said inner surface of the inner chamber, e.g. radial) greater than or equal to 3 cm, more preferably greater than or equal to 5 cm, and/or less than or equal to 15 cm, more preferably less than or equal to 12 cm.

Preferably said active surfaces are corrugated (for enhancing the smoothing). Preferably each projection comprises a respective plurality of protrusions at said active surface.

Preferably each protrusion has a height (i.e., a dimension taken along a direction perpendicular to said active surface), greater than or equal to 0.2 mm, more preferably greater than or equal to 0.5 mm, and/or less than or equal to 2 mm, more preferably less than or equal to 1.8 mm. Preferably the protrusions form a continuous pattern, e.g., a grid. In this way the protrusion can suitably contribute to the smoothening of the particles, as better explained below.

Preferably said tumble-drying comprises:
feeding said particles (preferably at room temperature) into said inner chamber at an open inlet of the tumble-drier;
rotating said hollow main body about said rotation axis for tumbling said particles.

The Applicant has realized that the rotation of the hollow main body generates a rubbing of the particles against the inner surface and possibly the projections, which is enhanced by the continuous lifting and falling (tumbling) of the particles. The mechanical interaction/collision helps smoothening any sharp edges present on the outer surface of the particles.

Preferably the active surfaces face forward during the rotation. In this way, the active surfaces collect the particles thus greatly enhancing the tumbling action (and possibly also providing the axial transport action) and the consequent smoothing action.

Preferably said tumble-drying comprises:
during rotation of the hollow main body, axially advancing said particles along said inner chamber from the open inlet to an open outlet of the tumble drier; and
outputting said particles from said open outlet (for obtaining output particles).

In this way the process can be carried out in a continuous way, thus favouring a time and/or costs saving. This is achieved thanks to the above structure of the projections, which behave as an endless screw.

Preferably said hollow main body (and said inner chamber) has a width taken along a direction perpendicular to the rotation axis, preferably in case of cylindrical shape a diameter of a cross-section of said hollow main body (and said inner chamber) perpendicular to the rotation axis, greater than or equal to 1 m, more preferably greater than or equal to 1.5 m, and/or less than or equal to 5 m, more preferably less than or equal to 4 m.

Preferably said hollow main body (and said inner chamber) has a length taken along the rotation axis greater than or equal to 5 m, more preferably greater than or equal to 7 m, and/or less than or equal to 20 m, more preferably less than or equal to 15 m.

Preferably a rotation speed of said hollow main body is greater than or equal to 3 rpm, more preferably greater than or equal to 4 rpm, and/or less than or equal to 12 rpm, more preferably less than or equal to 9 rpm.

The Applicant believes that the above rotation speed range associated to the above dimensions of the hollow main body (and the inner chamber) allow to carry out the tumble-drying operation in a suitable way (for obtaining the granules having the desired smoothened surface and/or moisture content), while keeping the production time compatible with the needs of an industrial process.

Preferably said tumble-drying comprises, preferably during said rotation, heating said particles. The synergic effect of the tumbling (rotation) and the heating allows to efficiently and simply dry the particles reducing the moisture content. In fact, the rotation and the consequent continuous mixing of the particles improves the uniformity of the heating and enhances the exposure of the particles to the heating source.

Preferably a maximum temperature of said particles during said heating is greater than or equal to 90° C., more preferably greater than or equal to 110° C., and/or less than or equal to 260° C., more preferably less than or equal to 220° C. In this way it is possible to substantially eliminate any microorganisms possibly still present on the plant material.

Preferably said heating comprises keeping said particles at a temperature greater than or equal to 80° (more preferably greater than or equal to) 100° and/or less than or equal to 250° C. (more preferably less than or equal to 220° C.), for a time interval greater than or equal to 120 s (more preferably greater than or equal to 180 s) and/or less than or equal to 420 s (more preferably lower than or equal to 360 s). In this way the particles are made free from microorganisms and dried.

Preferably, during said advancing said particles, a temperature of said particles during said heating varies according to a temperature profile along the axial direction from the open inlet to the open outlet. In this way it is possible to dry the particles while limiting the deterioration (e.g., scorching) of the plant material.

Preferably said heating comprises blowing hot air inside the inner chamber, preferably towards said particles (e.g., radially downward). In this way it is possible to heating the particles in a simple manner and also create an air flow directed from the inner chamber to the outer environment for efficiently removing the moisture evaporated from the plant material.

Preferably blowing hot air comprises blowing hot air at different locations distributed along the axial direction from the open inlet to the open outlet, more preferably the temperature of the hot air decreases moving from the open inlet to the open outlet.

Preferably a maximum temperature of the hot air (preferably in proximity of the open inlet) is greater than or equal to 200° C., more preferably greater than or equal to 220° C., and/or less than or equal to 300° C., more preferably less than or equal to 290° C. Preferably a minimum temperature of the hot air (preferably in proximity of the open outlet) is greater than or equal to 50° C., more preferably greater than or equal to 60° C., and/or less than or equal to 100° C., more preferably less than or equal to 90° C.

Preferably said tumble-drying (e.g., said advancing said particles from the open inlet to the open outlet) is carried out for a time interval greater than or equal to 150 s, more preferably greater than or equal to 200 s, even more preferably greater than or equal to 250 s, and/or less than or equal to 600 s, more preferably less than or equal to 550 s, even more preferably less than or equal to 500 s. In this way the production time are made compatible with the needs of an industrial process.

Preferably, after said tumble-drying (i.e., at the open outlet), a moisture content (measured according to ISO18134-1:2015) in said (output) particles is less than or equal to 25%, more preferably less than or equal to 20%, even more preferably less than or equal to 15%, of a moisture content in said particles before being subjected to said tumble-drying (i.e., at the open inlet). In this way the final granules have a moisture content that limits the uncontrolled/excessive proliferation of microorganisms when in use.

Preferably said granules have (substantially) round shape, elliptical shape or oval shape. More preferably said granules have round shape. In this way, in particular when the granules have round shape, it is possible to improve some performance properties of the synthetic turf surface on which the granules are used, e.g., the velocity of the ball on the surface with advantages in terms of playing easiness.

Preferably said granules have (sieve) size greater than or equal to 0.3 mm, more preferably greater than or equal to 0.4 mm, even more preferably greater than or equal to 0.5 mm, and/or less than or equal to 3 mm, more preferably less than or equal to 2.8 mm, even more preferably less than or equal to 2.5 mm. Preferably, after tumble-drying, it is provided sieving the particles for obtaining the granules with the above size.

Preferably said plant material is selected in the group: olive pits, pine cones, walnut shells, cork, or combinations thereof. In one particularly preferred embodiment said plant material is olive pits, more preferably said particles are integer olive pits (i.e., residual olive pits after oil extraction processes, mechanical and/or chemical, without any grinding or crushing). The Applicant believes that the large availability of this scrap materials, in particular of the olive pits, helps reducing the costs of the infill material.

Preferably said granules are entirely made of said plant material (in other words the granules are subjected only to mechanical and thermal actions, without the addition of any further materials/substances, possibly apart from a biocidal agent or a dye agent). In this way the granules are ecologically friendly.

Preferably the process further comprises (heterogeneously) mixing said granules with (different) infill particles. In this way an infill material is obtained which is a (heterogeneous) mixture of different kind of materials.

Preferably each of said infill particles comprises:
a polymeric matrix made of a polymeric material selected in the group: polylactic acid (PLA), polybutylene adipate terephthalate (PBAT), polyglycolic acid (PGA), polycaprolactone (PCL), poly(lactic-co-glycolic) acid (PLGA), poly-(2-hydroxyethyl-methacrylate), poly-ethylene-glycol (PEG), chitosan, hyaluronic acid, a poly-hydroxy-alkanoate (PHA), or combinations thereof;
a reinforcing filler dispersed in said polymeric matrix, the reinforcing filler being made of a further plant material.

Preferably the process comprises producing said infill particles by:
providing fragments of said further plant material;
providing a polymeric material selected in the above group;
heating and blending said fragments and said polymeric material for obtaining a blend comprising said polymeric material in softened state with said fragments dispersed in said polymeric material;
cooling said blend into solid state and grinding said cooled blend for obtaining said infill particles.

The Applicant has realized that the mixture of the granules and of the above composite infill particles allows to achieve a completely healthy, safe, biodegradable, recyclable (thus favouring a circular economy and a saving of costs) and ecological infill material which at the same time is low cost (since the cost of the raw material, e.g., the plant materials, is substantially null and since the re-use of materials is strongly incentivized) and has suitable performance properties, e.g., in terms of mechanical behaviour (e.g., shock absorption, bouncing of the ball, etc.) and/or water-retaining properties. Moreover, the above polymeric materials, when blended as above described, have a biodegradation kinetic which is suitable for use in an infill material (e.g., complete biodegradation in a time interval between 2-10 years) under the atmospheric conditions typically present where the synthetic turf surface is positioned (e.g., temperature ranging between 0-65° C., UR ranging between 30-90%, atmospheric pressure).

Preferably said infill particles are fibres. Preferably the fibres have a dimension (“length”) much greater (e.g., at least ten times, preferably at least twenty times, greater) than at least one of (preferably both) the other two dimensions (width and thickness). Preferably the fibres have a highly irregular shape (e.g., the surface of the fibre is jagged, possibly with thin, wry, filaments protruding from the surface). The fibrous, irregular, shape of the infill particles enhances the performance properties of the final infill material. For example, such fibrous, irregular, shape causes an intertwining of the fibres to form a “tangle” (where each fibre is mechanically bonded to the adjacent fibres) which provides a good stability of the fibres on the synthetic turf surface and which has a sponge-like overall structure provided by the void spaces between adjacent fibres of the “tangle”. The sponge-like structure provides a good cushioning/shock absorption of the stresses and/or good rebound of the ball and/or low “splash effect” and/or good water retaining properties by entrapping drops of water.

Preferably said heating and blending is performed in an extruder. In this way, the heating and blending is efficiently carried out.

Preferably said heating comprises bringing (at least) said fragments and said polymeric material to a temperature greater than or equal to a melting temperature of said polymeric material and less than or equal to a scorching temperature of said further plant material. In this way, it is possible avoiding a total burnout of the further plant material.

Preferably said further plant material is selected in the group: olive pits, pine cones, wood sawdust, coconut fibre/peat, cork, rice husk, banana fibre/peat, lignin, tree defibration, hemp, corn pits, or combinations thereof, more preferably said further plant material is the same as said plant material. In this way, the cost of the infill particles is limited (given the use of scrap materials) and, furthermore, easily disposable materials are used, thus reducing the risk of pollution for the environment.

Preferably said blend (e.g., said infill particles) comprises a weight percentage of said further plant material greater than or equal to 5%, more preferably greater than or equal to 10% mm, and/or less than or equal to 50%, more preferably less than or equal to 40%, of an overall weight of said blend (or infill particles).

In one preferred embodiment providing said fragments comprises tumble-drying said further plant material, more preferably according to any of the above tumble-drying embodiments. In this way the process is optimized, since the same tumble-drying operation can provide both the granules which, as such, form part of the infill material, and (preferably after grinding) the fragments to be used as raw material for the infill particles. The Applicant has also observed that the tumble-dried fragments have a low moisture content which helps to maintain a dry environment (e.g., low amount of moisture that evaporates) during the heating operation, especially when performed in an extruder. Preferably said providing said fragments comprises, more preferably after said tumble-drying said further plant material, grinding said further plant material, preferably for obtaining said fragments with size less than 1 mm.

Preferably said polymeric material is selected in the group: polylactic acid (PLA), polybutylene adipate terephthalate (PBAT), polyglycolic acid (PGA), polycaprolactone (PCL), poly(lactic-co-glycolic) acid (PLGA), or combinations thereof. In one particularly preferred embodiment said polymeric material is polylactic acid (PLA). The Applicant has realized that these polymeric materials can be easily processed with many industrial techniques (e.g., extrusion) thus simplifying the production of the infill particles. Moreover, the biodegradation kinetic of these materials is particularly suitable for use in an infill material. In particular, the PLA is particularly suitable since the biodegradation kinetic of the resulting composite material (when blended with the further plant material) may be higher (i.e., the biodegradation is faster) than the biodegradation kinetic of the PLA as such (which typically only occurs in certain conditions, e.g., temperature above 60° C.).

Preferably said blend (e.g., said infill particles) comprises a weight percentage of said polymeric material greater than or equal to 40%, more preferably greater than or equal to 50%, even more preferably greater than or equal to 60% mm, and/or less than or equal to 95%, more preferably less than or equal to 90%, of an overall weight of said blend (or infill particles).

Preferably the process further comprises providing a plasticizing agent and heating and blending said plasticizing agent with said fragments and said polymeric material. Preferably said plasticizing agent is an epoxidized vegetable oil (preferably selected in the group of epoxidized Vernonia oil, epoxidized linseed oil and epoxidized soybean oil (ESBO)). More preferably said plasticizing agent is epoxidized soybean oil (ESBO).

Preferably said blend (e.g., said infill particles) comprises a weight percentage of said plasticizing agent greater than or equal to 1.5%, more preferably greater than or equal to 2% mm, and/or less than or equal to 12%, more preferably less than or equal to 10%, of an overall weight of said blend (or infill particles).

The addition of a plasticizing agent enhances the workability of the polymeric material and/or the embedding of the further plant material in the polymeric matrix, since the plasticizing agent makes the polymeric material softer (e.g., decrease its viscosity) and more flexible (e.g., increase its plasticity). Moreover, the Applicant has observed that the above plasticizing agents have a biodegradation kinetic suitable for use in an infill material and favour the formation of the fibrous shape of the infill particles by grinding the blend.

Preferably the process further comprises providing a biocidal agent and heating and blending said biocidal agent with said fragments and said polymeric material.

Preferably said blend (e.g., said infill particles) comprises a weight percentage of said biocidal agent greater than or equal to 0.1%, more preferably greater than or equal to 0.2%, and/or less than or equal to 5%, more preferably less than or equal to 3%, of an overall weight of said blend (or said infill particles).

Preferably said biocidal agent is selected in the group: organic silanes (preferably dimethyl-dichloro-silanes; trimethylsilyl-chlorides; trimethoxysilyl-chlorides; methyl-trichloro-silanes), chlore-based biocidal agents (preferably chlorophenoxy-phenol, e.g., 5-chloro2-(4-chlorophenoxy)-phenol), zinc-based biocidal agents (e.g., zinc pyrithione), or combinations thereof. The Applicant has found that these components allow for a high protection against microorganisms that could possibly proliferate on the synthetic turf surface.

According to a further aspect the invention relates to a synthetic turf surface comprising a synthetic turf mat and a layer of infill material arranged above said synthetic turf mat, wherein the infill material is produced by a process for production according to any embodiment of the present invention. In this way, the desired performance properties (e.g., in terms of wear resistance and/or low abrasion risk for the users and/or adherence for the users) and/or the desired aesthetic properties (e.g., likelihood to the natural grass) are provided to the synthetic turf surface.

Preferably said layer of infill material has a percentual weight content of said granules greater than or equal to 50%, more preferably greater than or equal to 60%, even more preferably greater than or equal to 70%, and/or less or equal to 95%, of an overall weight of said infill material (more preferably a rest of the infill material being formed by said infill particles). In this way it is possible reducing the total cost of the infill material.

Preferably said layer of infill material has a mass per unit area greater than or equal to 2 kg/m², more preferably greater than or equal to 4 kg/m², even more preferably greater than or equal to 5 kg/m², and/or less than or equal to 15 kg/m², more preferably lower or equal to 12 kg/m², even more preferably less than or equal to 10 kg/m². In this way, the appropriate amount of infill material is provided for giving the desired properties to the synthetic turf surface.

### BRIEF DESCRIPTION OF THE DRAWINGS

FIG. 1 schematically shows in vertical section a synthetic turf surface comprising a layer of the infill material produced according to the present invention;

FIG. 2a shows a block diagram of a plant for carrying out a process for production according to the present invention;

FIG. 2b shows a block diagram of a station of the plant of FIG. 2a;

FIG. 3 schematically and partially shows a tumble-drier that can be used for carrying out a process for production according to the present invention;

FIG. 4 schematically and partially shows a detail of the tumble-drier of FIG. 3;

FIG. 5 schematically shows a graph of an example of temperature profile of the particles during the tumble-drying operation according to the present invention;

FIG. 6 shows a picture of the infill particles according to the present invention.

### DETAILED DESCRIPTION OF SOME EMBODIMENTS OF THE INVENTION

The features and the advantages of the present invention will be further clarified by the following detailed description of some embodiments, presented by way of non-limiting example of the present invention, with reference to the attached figures. All the figures are shown not in scale, and only for illustrative purpose.

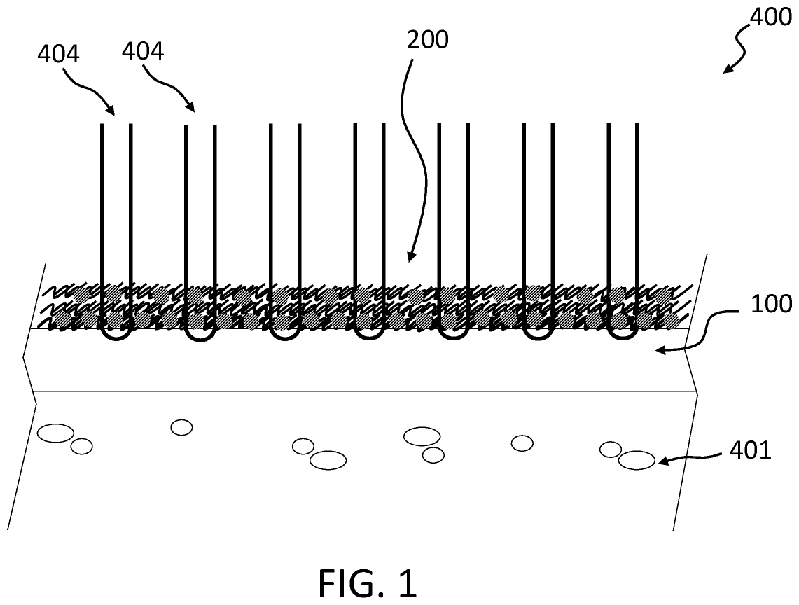

With reference to FIG. 1, it is schematically shown a synthetic turf surface 400 comprising a compact clay substrate 401 (for example as known) and a synthetic turf mat 100 (e.g., of known type and not further described) laid on the substrate 401. Typically, the synthetic turf mat 100 comprises a plurality of artificial fibres 404 (which simulate the grass threads) for example woven by tufting in the synthetic turf mat 100. The synthetic turf surface 400 further comprises one layer of infill material 200 arranged on the synthetic turf mat 100 between the artificial fibres 404. Exemplarily the layer 200 has a thickness equal to about 10 mm and a mass per unit area exemplarily equal to about 5.5 kg/m².

Typically, the infill material 200 is a performance infill of the synthetic turf surface 400 and therefore is arranged at the top of the infill system. Typically, under the layer of infill material 200, a layer of stabilizing infill material (not shown), exemplarily made of sand or pea gravel, is arranged on the synthetic turf mat 100.

The infill material 200 comprises a plurality of granules 201 entirely made of a plant material processed according to the present invention. Exemplarily the granules 201 are processed entire olive pits.

Exemplarily the granules 201 have generally round shape and exemplarily have a sieve size between 0.5 mm and 2.5 mm.

In one embodiment the granules 201 are not treated with any biocidal agent.

The infill material 200 exemplarily further comprises a plurality of infill particles 202, e.g., the infill material 200 is a heterogeneous mixture of the granules 201 and of the infill particles 202, wherein the granules and the infill particles are mixed together and do not form two respective distinct layers. Exemplarily, in the mixture, a percentual weight content of the granules 201 is equal to about 90% and a percentual weight content of the infill particles 202 is equal to about 10%.

Exemplarily each of the infill particles 202 is a composite particle comprising a polymeric matrix exemplarily made of polylactic acid (PLA) and a reinforcing filler dispersed in the polymeric matrix, wherein the reinforcing filler is exemplarily made of olive pits.

In one alternative embodiment, not shown, the infill material 200 consists solely of the granules 201.

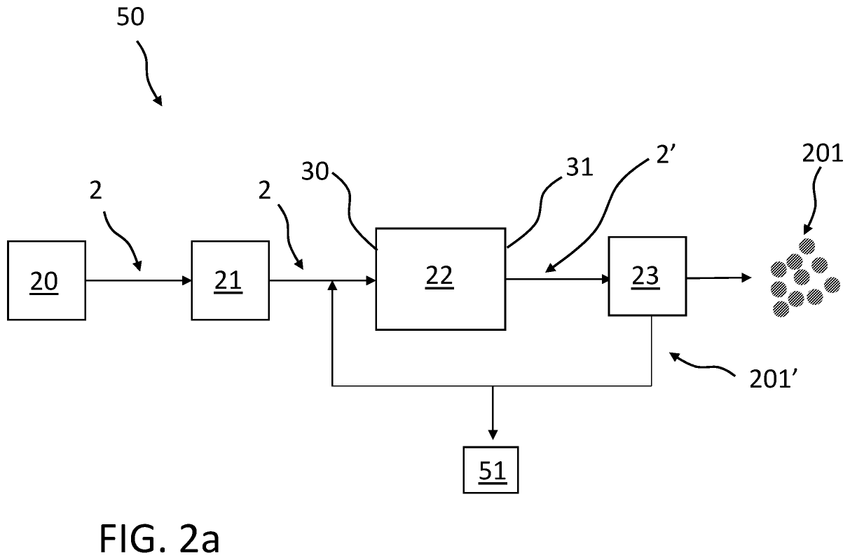

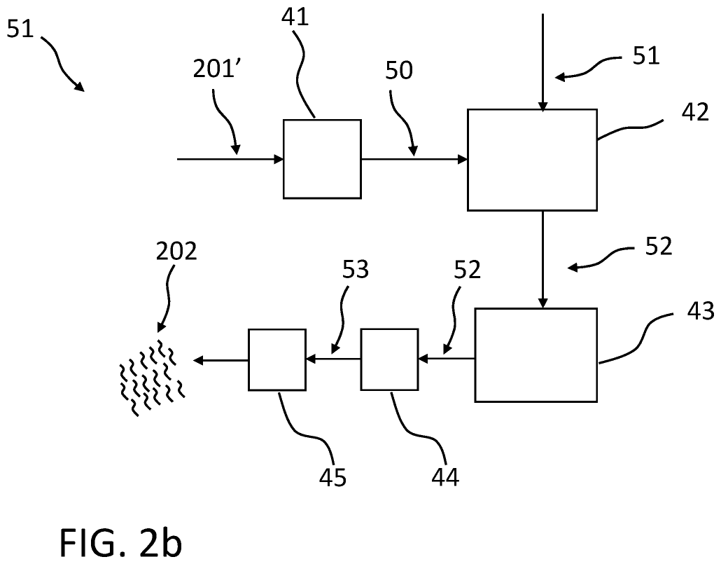

FIG. 2a schematically shows a plant 50 for carrying out a process of the present invention. It is noted that the scheme shown in FIG., 2a may also represent a flow diagram of a process of the present invention.

Firstly, particles 2 of a plant material, in the example olive pits, are provided in a container 20. Particles 2 exemplarily are integer olive pits, i.e., residual olive pits after oil extraction processes (mechanical and/or chemical).

Secondly, the particles 2 may be washed, exemplarily by means of immersion in water (e.g., in a water bath 21) for the purposes of reducing, or eliminating, the possible presence of contaminating agents (e.g., microorganisms, impurities, toxic substances).

After washing, the particles 2 may be partially dried (e.g., left exposed to ambient temperature). The particles 2 are fed to a tumble-drier 22 in which the tumble-drying operation is carried out.

Preferably the entire olive pits 1 are not grinded or crushed before carrying out the tumble-drying operation.

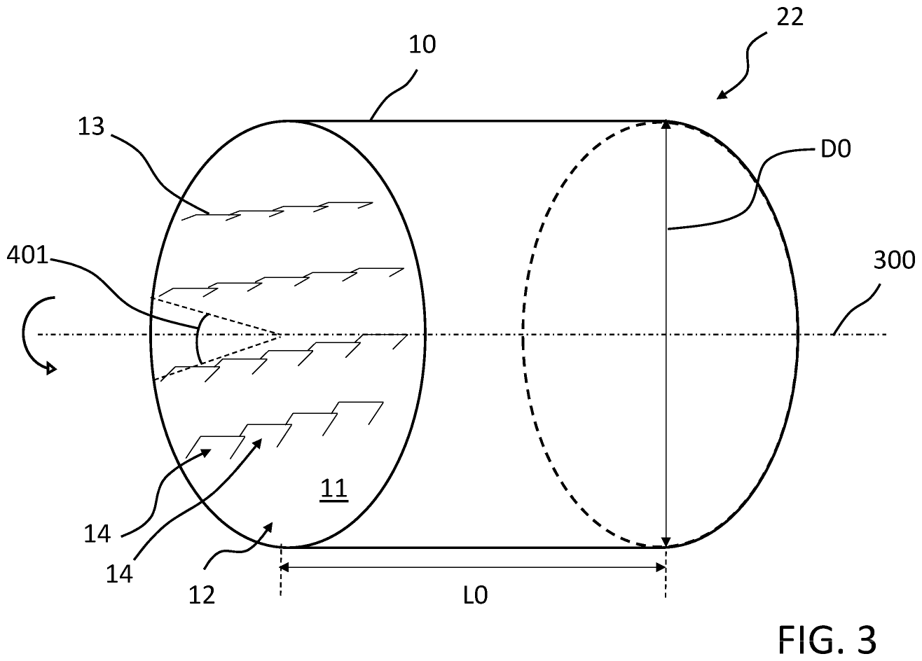

An example of a tumble drier for carrying out the tumble-drying operation is shown with reference to FIG. 3.

The tumble drier 22 exemplarily comprises a hollow main body 10, exemplarily made of steel, rotatable (e.g., counter-clockwise) around an exemplarily horizontal rotation axis 300.

Exemplarily the hollow main body 10 comprises an inner chamber 12 and an inner surface 11 defining the inner chamber 12. Exemplarily the hollow main body 10, the inner chamber 12 and the inner surface 11 have cylindrical shape, symmetric with respect to the rotation axis 300 (i.e., the cross section has a circular shape). In one alternative embodiment (not shown) the hollow main body may have for example an oval, elliptical or even square or rectangular cross-section, centred to the rotation axis. It is preferable that the inner chamber has cylindrical shape in order to maximize the area of the inner surface for a given volume of the inner chamber.

Exemplarily the diameter D0 of the cross-section of the cylindrical hollow main body 10 (and of the inner chamber 12) is equal to about 2 m. Exemplarily the hollow main body 10 and the inner chamber 12 have a total axial length L0 equal to about 10 m.

Exemplarily the hollow main body 10 comprises a plurality of projections 13 (only partially and schematically shown) radially protruding from the inner surface 11.

Exemplarily the projections 13 are a plurality of lamellae, exemplarily having a laminar and rectangular shape.

In one alternative not shown embodiment the projections may be in the shape of spikes distributed on the inner surface.

Exemplarily the lamellae 13 are distributed on the inner surface 11 of the hollow main body 12 in rows, exemplarily in number equal to thirty (only partially and schematically shown).

Exemplarily each row comprises a sequence of lamellae 13, the sequence developing substantially along the axial direction in order to form a respective active surface 14 (in the example the bottom surface of the lamellae, i.e., the surface of the lamellae that faces the rotation direction). The lamellae 13 of each pair of consecutive lamellae of a respective row are physically separated along the axial direction.

In one alternative not shown embodiment one or more projections, and the respective active surfaces, continuously develop along the entire length of the hollow main body (i.e., each projection may be a single, linear, and continuous body, which develops along the entire length of the hollow main body substantially axially). For example, the lamellae of each pair of lamellae of a respective row may be physically linked by a respective connecting element, which for example connects two adjacent edges of two consecutive lamellae.

Exemplarily the active surfaces 14 are not parallel to the rotation axis 300 and develop helicoidally around the rotation axis to form respective helixes. Exemplarily a pitch of the helix is equal to about one and a half time the length L0. Exemplarily, in each row, the lamellae 13 of each pair of consecutive lamellae are partially circumferentially staggered on a same side (in order to form the helix), and partially mutually overlapped with respect to the axial direction (in order to limit, or avoid, the olive pits to fall back-ward).

In one alternative embodiment (not shown) the active surfaces are parallel to the rotation axis. In this case the tumble-drier does not exert an axial transport and it may act as a batch tumble-drier, rather than a continuous one.

Exemplarily the active surfaces 14 are evenly angularly distributed around the rotation axis 300 on the cross section. In other words, an angular distance 401 taken on the cross section of the inner chamber 12 between two adjacent active surfaces 14 (or rows of lamellae 13) is constant and exemplarily equal to about 12°.

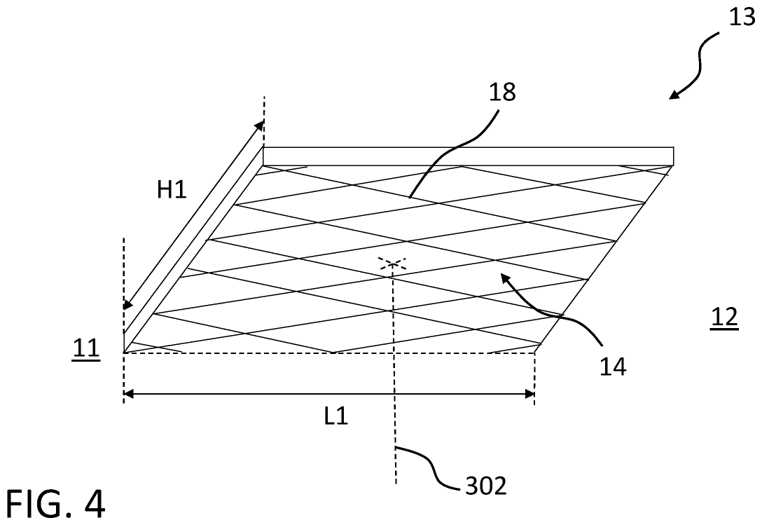

With reference to FIG. 4, it is shown a possible structure of each of the lamellae 13 described above. Exemplarily each of the lamellae 13 has an axial length L1 equal to about 25 cm, and a radial height H1 exemplarily equal to about 8 cm.

Exemplarily the side of each lamella 13 facing forward during rotation (and hence forming part of the respective active surface 14) is corrugated. Exemplarily each lamella 13 comprises a respective plurality of protrusions 18 at the active surface 14. Exemplarily each protrusion 18 has a height, i.e., a dimension taken along a direction 302 perpendicular to the active surface 14, equal to about 1 mm. Exemplarily the protrusions 18 form a continuous pattern on the active surface 14, e.g., a grid having rhomboidal pattern. In general, the grid may define a pattern having any shape, e.g., rectangular, quadratic, triangular, etc.

In one alternative not shown embodiment the protrusions may be discontinuous protuberances protruding from the active surface, for example in the shape of spikes, or obtained by surface treatment (e.g., sand-paper surface).

Going now back to FIG. 2a, the tumble-drying operation is described. The tumble-drying exemplarily comprises:
feeding the particles 2, exemplarily at room temperature, into the inner chamber 12 at an open inlet 30 of the tumble-drier 22;
rotating (e.g., by means of a pneumatic or electric motor) the hollow main body 10 about the rotation axis 300 for tumbling the particles 2;
during rotation of the hollow main body 10, axially (i.e., along the rotation axis 300) advancing the particles 2 along the inner chamber 12 from the open inlet 30 to an open outlet 31 of the tumble drier 22; and
outputting the tumble-dried particles 2′ from the open outlet 31.

Exemplarily a rotation speed of the hollow main body 10 is equal to about 6 rpm.

Exemplarily the tumble-drying (e.g., during the rotation of the hollow main body 10) comprises also heating the particles 2. Exemplarily the heating comprises blowing hot air inside the inner chamber 12 (e.g., by way of one or more air blowers, not shown). For this purpose, the tumble drier 22 may comprise a plurality of air outlets (not shown) located inside the inner chamber 12 (e.g., at the top of the inner chamber) at different locations distributed along the axial direction from the open inlet 30 to the open outlet 31.

In one alternative embodiment the heating is performed by means of one or more infrared sources which irradiate the particles, the infrared sources being exemplarily housed in the inner chamber and exemplarily distributed along the axial direction from the open inlet to the open outlet.

Exemplarily the blown hot air has a temperature progressively decreasing moving along the axial direction from the open inlet 30, in proximity of which the air has temperature exemplarily equal to about 270° C., to the open outlet, in proximity of which the air has temperature exemplarily equal to about 70° C.

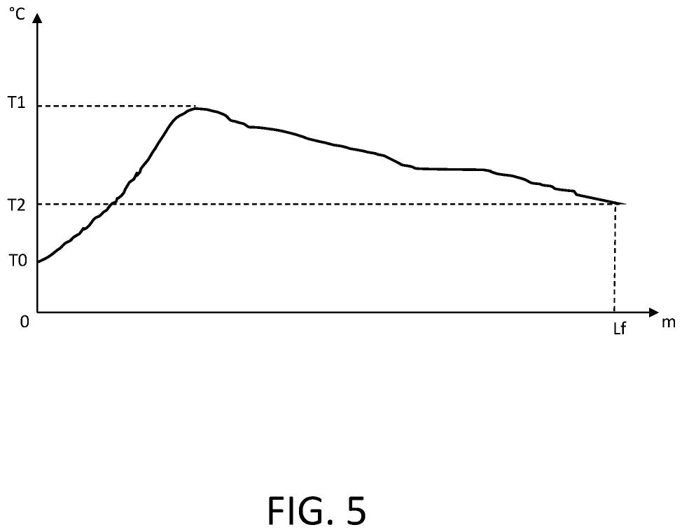

With reference to FIG. 5, it is shown an example of a temperature profile of the particles 2 along the axial direction from the open inlet 30 (corresponding to the zero on the x-axis of the graph) to the open outlet 31 (corresponding to point Lf on the x-axis of the graph).

Exemplarily, the particles 2 are fed at T0 (exemplarily equal to ambient temperature) in the tumble drier 22. In proximity of the open inlet 30, the air at 270° C. heats the particles 2 up to a maximum temperature T1 exemplarily equal to about 130° C. After that, since the temperature of the air decreases as explained above, the particles 2 progressively cool down until an output temperature T2 at the open outlet 31 exemplarily equal to about 90° C.

Preferably the process further comprises letting the tumble-dried particles 2′ cool down to room temperature.

Exemplarily a moisture content measured according to ISO18134-1:2015 in the particles 2′ at the open outlet 31 (e.g., after cooling at room temperature) is equal to about 11-12% of a moisture content in the particles 2 at the open inlet 30.

Exemplarily the advancing (and the heating) of the particles 2 from the open inlet 30 to the open outlet 31 is carried out for a time interval equal to about 360 s.

Exemplarily the tumble-dried particles 2′ in output from the tumble-drier 22 can be sieved, e.g. by means of a sieving device 23 (for example of known type), for obtaining the granules 201 with the above sieve size (0,5-2,5 mm).

The scrap particles 201′ (tumble-dried and sieved) outside the desired sieve size can be recycled in various way.

For example, the particles 201′ exceeding the desired sieve size can be brought back at the open inlet 30 of the tumble-drier 22 in order to be subjected again to the tumble-drying operation which can reduce their size.

For example, the particles 201′ (above and/or below the desired sieve size) can be fed to a station 51 for producing the infill particles 202.

FIG. 2b schematically shows the station 51. It is noted that the scheme shown in FIG. 2b may also represent a flow diagram of a process for producing the infill particles 202.

Firstly, fragments 50 of a plant material (which may be the same of the particles 2 or different) are provided.

Exemplarily, the fragments 50 are fragments of olive pits obtained by grinding the scrap particles 201′. Alternatively, or in combination, integer olive pits such as the above particles 2′, or the granules 201, i.e., respectively before or after sieving, or integer olive pits (after oil extraction) dried by a different drying process such as by oven treatment, can be used as raw material to be grinded for obtaining the fragments 50.

The grinding is exemplarily carried out by feeding the raw material (e.g., scrap particles 201′) to one or more grinding mills 41 (only schematically shown) in which for example there is a respective blades/counter-blades system (for example of known type). For example, the grinding can comprise a coarse pre-grinding of the particles 201′ and a subsequent fine grinding. In this way about 85-90% in weight of the fragments 50 has size less than or equal to 1 mm (this favours the incorporation of the fragments in the polymeric matrix as explained below).

After grinding, the fragments 50 are fed together with an amount 51 of polylactic acid (exemplarily dried, e.g., by a dehumidifier) to an extruder 42. Exemplarily, the extruder 42 is a twin-screw extruder with co-rotating screws at least partially penetrating. Exemplarily the working condition of the twin-screw extruder are: rotation velocity of the screws equal to about 300 rpm and pressure equal to about 30 bar.

Exemplarily, together with the fragments 50 and the polylactic acid (PLA), the following components can be fed to the extruder 42:
a plasticizing agent, for example epoxidized soybean oil (ESBO), having CAS number: 8013-07-8;
an anti-oxidant additive (e.g., having thermo-stabilizing function), an anti-UV-rays additive, and a dye;
a biocidal agent, for example a trimethoxysilyl-chloride having CAS number: 19911-50-70, or 5-chloro2-(4-chlorophenoxy)-phenol having CAS number: 3380-30-1.

For example, the extruder 42 comprises a plurality of feeding mouths distributed along the screw development direction of the extruder 42. The feeding of the above components can be performed either to the same feeding mouth or to feeding mouths spatially separated from each other. In this way, the components can be blend and/or heated at a different extent (e.g., different time intervals). Alternatively, or in combination, the process can provide preparing a mixture of one or more of the above components inside a further mixing device (for example of known type), the latter acting as a tank for feeding the mixture to the extruder. For example, the further mixing device comprises a stirring and feeding device which carries out a forced mixing of the components for obtaining the mixture and the feeding of a predetermined amount of mixture to the extruder.

In the extruder 42, the components are heated, exemplarily to a temperature equal to about 190° C., and blended for obtaining a (heterogeneous) blend comprising the PLA in a softened state and all the other components (including the fragments 50) dispersed and/or distributed in the PLA. Exemplarily the extruder 42 comprises a series of heating elements (of known type, not shown) for allowing the heating. The blending of the blend, as well as its displacement along the extruder, is carried out by the rotation of the screws of the extruder 42 (which are at least partially helicoidal screws).

Exemplarily the components fed into the extruder 42 enters, by rotation of the screws, in a compression area wherein the blend is formed, with the PLA that softens when subjected to strong pressures and heat application.

Exemplarily the final blend comprises the following composition: 57% of PLA, 30% of fragments, 7% of ESBO, 1% of anti UV-rays additive, 1% of anti-oxidant additive, 3% of dye and 1% of biocidal agent.

Finally, the blend is moved towards the extrusion/outlet head of the extruder 42 for being extruded, exemplarily in the form of a continuous stripe 52 which is transported, e.g., by a pulley system and/or a roller system (not shown), to a cooling station 43 for being cooled. Exemplarily the cooling station 43 comprises one or more containers (e.g., in series) with water at room temperature, with the continuous stripe 52 that is immersed in the water and, after the cooling operation, transported to a drying station (not shown), exemplarily comprising an air blower, for being dried.

Once the continuous stripe 52 has been dried, it is pelletized (for example by a suitable pelletizer 44 of known type) to obtain pellets 53 of blend. The pellets 53 of blend are then exemplarily continuously fed to a grinding mill 45 which carries out a grinding of the pellets 53 of blend for obtaining the infill particles 202.

Exemplarily, the grinding mill 45 comprises a further sieving device (not shown) which cooperates with the grinder and avoids that the infill particles 202 are ejected before the desired size is obtained.

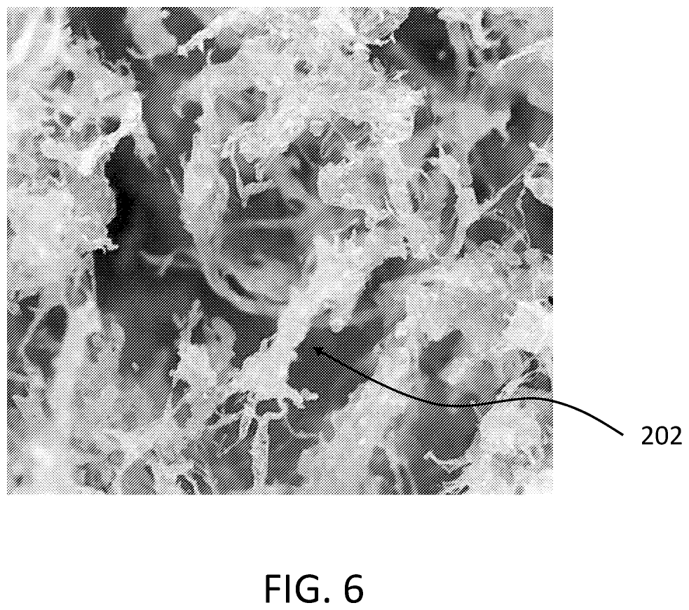

Exemplarily the infill particles 202 are in the form of fibres, as shown in FIG. 6 which represents a photograph of the fibres 202 taken at the microscope. Exemplarily the fibres have a main dimension, which is exemplarily called “length”, greater than both its width and thickness. Exemplarily the fibres 202 have an average length equal to about 3 mm and an average thickness exemplarily equal to about 50 μm. These average dimensions of the fibres have been exemplarily taken by microscope measurement with a statistical approach (e.g., the average dimensions are obtained by the ratio between the length of the “field of view” of the microscope, having a standard dimension, and the number of fibres needed for entirely occupying the “field of view”).

Exemplarily the fibres 202 have a jagged profile along the main dimension (the length) with thin, wry, filaments protruding from their surface (as shown in FIG. 6). This helps the entanglement of the fibres and the formation of a sponge-like structure, as explained above.

The granules 201 and the fibres 202 can then be stored in sacks (or other type of containers) in the desired proportion (i.e., already forming the mixture with the desired weight content of granules 201, exemplarily equal to about 90%, and of infill particles 202, exemplarily equal to about 10%). In this way the realization of the layer of infill material can be simplified.

1. Process for production of an infill material for a synthetic turf surface, wherein the infill material comprises a plurality of granules, the process comprising:
providing particles made of a plant material; and
tumble-drying said particles for obtaining said granules.

2. Process according to claim 1, wherein said tumble-drying is carried out for a time interval greater than or equal to 150 s and less than or equal to 600 s, and wherein the tumble-drying comprises:
providing a tumble-drier comprising a hollow main body rotatable around a rotation axis and having cylindrical shape symmetric with respect to said rotation axis, wherein said hollow main body comprises an inner chamber and an inner surface defining said inner chamber;
feeding said particles into said inner chamber at an open inlet of the tumble-drier; and
rotating said hollow main body about said rotation axis for tumbling said particles.

3. Process according to claim 2, wherein said tumble-drying comprises:
during rotation of the hollow main body, axially advancing said particles along said inner chamber from the open inlet to an open outlet of the tumble drier; and
outputting said particles from said open outlet, wherein the process further comprises, after said tumble-drying, sieving the output particles for obtaining the granules with a sieve size greater than or equal to 0.3 mm and less than or equal to 3 mm.

4. Process according to claim 2, wherein said tumble-drying comprises heating said particles during said rotating, wherein a maximum temperature of said particles during said heating is greater than or equal to 90° C. and less than or equal to 260° C., wherein said heating comprises keeping said particles at a temperature greater than or equal to 80° and less than or equal to 250° C. for a time interval greater than or equal to 120 s and less than or equal to 420 s, wherein said heating comprises blowing hot air inside the inner chamber at different locations distributed along an axial direction parallel to the rotation axis from an open inlet to an open outlet of the tumble drier, and wherein a temperature of the hot air decreases moving from the open inlet to the open outlet.

5. Process according to claim 2, wherein said hollow main body comprises a plurality of projections protruding from the inner surface, wherein said projections form a plurality of active surfaces each one developing along an entire axial length of said hollow main body, wherein said active surfaces are evenly distributed on the inner surface and face forward during said rotating, and wherein each active surface forms a helix around the rotation axis having a pitch greater than or equal to half of a total length and less than or equal to two times said entire axial length.

6. Process according to claim 5, wherein the active surfaces form, together with the inner surface, an endless screw along the axial direction, wherein the active surfaces are corrugated, wherein each projection comprises a respective plurality of protrusions forming a continuous pattern at said active surface, and wherein each protrusion has a height greater than or equal to 0.2 mm and less than or equal to 2 mm.

7. Process according to claim 5, wherein said projections comprise a plurality of lamellae each having a laminar shape, wherein said lamellae are distributed on said inner surface of the hollow main body in rows, each row comprising a sequence of lamellae developing along an axial direction parallel to the rotation axis for forming a respective active surface, wherein, in each row, the lamellae of each pair of consecutive lamellae are at least partially circumferentially staggered and partially mutually overlapped with respect to the axial direction.

8. Process according to claim 2, wherein said hollow main body has a diameter of a cross-section of said hollow main body perpendicular to the rotation axis greater than or equal to 1 m and less than or equal to 5 m, wherein said hollow main body has a length taken along the rotation axis greater than or equal to 5 m and less than or equal to 20 m, and wherein a rotation speed of said hollow main body is greater than or equal to 3 rpm and less than or equal to 12 rpm.

9. Process according to claim 1, comprising, before said tumble-drying, washing said particles, wherein, after said tumble-drying, a moisture content in said particles is less than or equal to 25% of a moisture content in said particles before said tumble-drying, wherein said granules have round shape, elliptical shape or oval shape, wherein said granules are entirely made of said plant material, and wherein said particles are integer olive pits.

10. Process according to claim 1, comprising mixing said granules with infill particles, wherein each of said infill particles comprises:
a polymeric matrix made of a polymeric material selected in the group: polylactic acid (PLA), polybutylene adipate terephthalate (PBAT), polyglycolic acid (PGA), polycaprolactone (PCL), poly(lactic-co-glycolic) acid (PLGA), poly-(2-hydroxyethyl-methacrylate), poly-ethylene-glycol (PEG), chitosan, hyaluronic acid, a poly-hydroxy-alkanoate (PHA), or combinations thereof; and
a reinforcing filler dispersed in said polymeric matrix, the reinforcing filler being made of a further plant material.

11. Process according to claim 10, comprising producing said infill particles by:
providing fragments of said further plant material;
providing said polymeric material;
heating and blending said fragments and said polymeric material for obtaining a blend comprising said polymeric material in softened state with said fragments dispersed in said polymeric material; and
cooling said blend into solid state and grinding said cooled blend for obtaining said infill particles.

12. Process according to claim 10, wherein said infill particles are fibres having a dimension at least ten times greater than both the other two dimensions, wherein a surface of the fibre is jagged, with thin, wry, filaments protruding from the surface.

13. Process according to claim 10, wherein providing said fragments comprises tumble-drying said further plant material and, after said tumble-drying said further plant material, grinding said further plant material for obtaining said fragments with size less than 1 mm, and wherein said heating and blending is performed in an extruder.

14. Process according to claim 10, comprising:
providing a plasticizing agent selected in the group of epoxidized Vernonia oil, epoxidized linseed oil and epoxidized soybean oil (ESBO);
providing a biocidal agent selected in the group organic silanes, chlore-based biocidal agents, zinc-based biocidal agents, or combinations thereof; and
heating and blending said plasticizing agent and said biocidal agent with said fragments and said polymeric material, and wherein said blend comprises:
a weight percentage of said further plant material greater than or equal to 5% and less than or equal to 50% of an overall weight of said blend;
a weight percentage of said polymeric material greater than or equal to 40% and less than or equal to 95% of an overall weight of said blend;
a weight percentage of said plasticizing agent greater than or equal to 1.5% and less than or equal to 12% of an overall weight of said blend; and
a weight percentage of said biocidal agent greater than or equal to 0.1% and less than or equal to 5% of an overall weight of said blend.

15. Synthetic turf surface comprising a synthetic turf mat and a layer of infill material arranged above said synthetic turf mat, wherein the infill material is produced by the process for production according to claim 1, wherein said layer of infill material has a percentual weight content of said granules greater than or equal to 50% of an overall weight of said infill material, and wherein said layer of infill material has a mass per unit area greater than or equal to 2 kg/m² and less than or equal to 15 kg/m².
